(19) United States
(12) Patent Application Publication
(10) Pub. No.: US 2016/0299671 A1
(43) Pub. Date: Oct. 13, 2016

(54) Opening New Application Window in Response to Remote Resource Sharing

(71) Applicants: Yu An, Sammamish, WA (US); Prarthana Panchal Johnson, Seattle, WA (US); Mark Robert Swift, Mercer Island, WA (US); John Cole Bradley, Seattle, WA (US); Thaddeus Adam Scott, Seattle, WA (US); Phillip Dean Garding, North Bend, WA (US); Stephen Hoyt Houchen, Redmond, WA (US)

(72) Inventors: Yu An, Sammamish, WA (US); Prarthana Panchal Johnson, Seattle, WA (US); Mark Robert Swift, Mercer Island, WA (US); John Cole Bradley, Seattle, WA (US); Thaddeus Adam Scott, Seattle, WA (US); Phillip Dean Garding, North Bend, WA (US); Stephen Hoyt Houchen, Redmond, WA (US)

(21) Appl. No.: 14/683,942

(22) Filed: Apr. 10, 2015

(51) Int. Cl. G06F 3/0484; G06F 3/0481

(52) U.S. Cl. CPC G06F 3/04847; G06F 3/04817; G06F 3/04842

(57) ABSTRACT

In at least some embodiments, when a participant in an online meeting begins to share a resource, such as their display screen, a new application window is automatically opened on a meeting room device and content associated with the participant's computing device is shared within the new application window. The participant can be a person in close proximity to the meeting room device. Alternately or additionally, the participant can be a remote participant.

### BACKGROUND

Meeting software enables individuals to conduct group meetings in efficient ways. For example, the group of individuals can meet in a meeting room and, through the use of meeting software, can conduct a meeting, share resources, conference other remote participants into the meeting, and the like. As meeting software evolves, challenges remain to provide improved meeting software that enables participants to even more efficiently conduct meetings and share resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In at least some embodiments, when a participant in an online meeting begins to share a resource, such as their display screen, a new application window is automatically opened on a meeting room device and content associated with the participant's computing device is shared within the new application window.

In at least some embodiments, the meeting room device includes a so-called application stage. The application stage represents a display area within which applications may run. In response to a participant sharing a resource, the position(s) and size(s) of windows within the application stage are changed to accommodate a new application window associated with the shared resource. Content associated with the participant's computing device can then be shared within the new application window.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example meeting room device in accordance with one or more embodiments.

FIG. 2 is an illustration of an example environment in accordance with one or more embodiments.

FIG. 3 is an illustration of an example meeting room device in accordance with one or more embodiments.

FIG. 4 is an illustration of an example meeting room device in accordance with one or more embodiments.

FIG. 5 is an illustration of an example meeting room device in accordance with one or more embodiments.

FIG. 6 is a flow diagram that describes steps in a method in accordance with one or more embodiments.

FIG. 7 illustrates an example meeting room device that can be utilized to implement various embodiments described herein.

### DETAILED DESCRIPTION

Overview

In at least some embodiments, when a participant in an online meeting begins to share a resource, such as their display screen, a new application window is automatically opened on a meeting room device and content associated with the participant's computing device is shared within the new application window. The participant can be a person in close proximity to the meeting room device. Alternately or additionally, the participant can be a remote participant.

In at least some embodiments, the meeting room device includes a so-called application stage. The application stage represents a display area within which applications may run. In response to a participant sharing a resource, the position(s) and size(s) of windows within the application stage are changed to accommodate a new application window associated with the shared resource. Content associated with the participant's computing device can then be shared within the new application window. An application that was running in the application stage can still continue to run while content associated with the participant's computing device is shared within the new application window.

In the following discussion, an example environment is first described that is operable to employ the techniques described herein. The techniques may be employed in the example environment, as well as in other environments.

### Example Environment

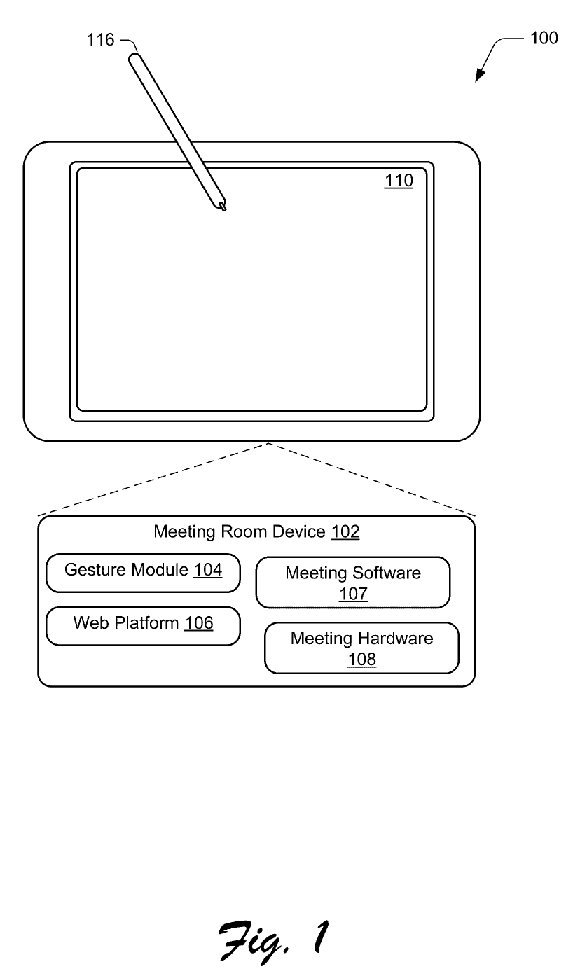

FIG. 1 is an illustration of an environment 100 in an example implementation that is operable to employ the techniques as described herein. The illustrated environment 100 includes an example of a meeting room device 102 that may be configured in a variety of ways. In this example, meeting room device 102 represents a computing device that is utilized to plan and conduct a meeting. The meeting room device 102 typically resides in a meeting room, conference room, or in an open area in which many different types of meetings can take place. As such, meeting room device 102 can have what can be considered as a “communal” nature. This means that the meeting room device can be used by various different groups to conduct their meetings. These various different meetings can be unrelated to each other such that content that is the subject of one meeting may not be relevant to content that is the subject of another meeting.

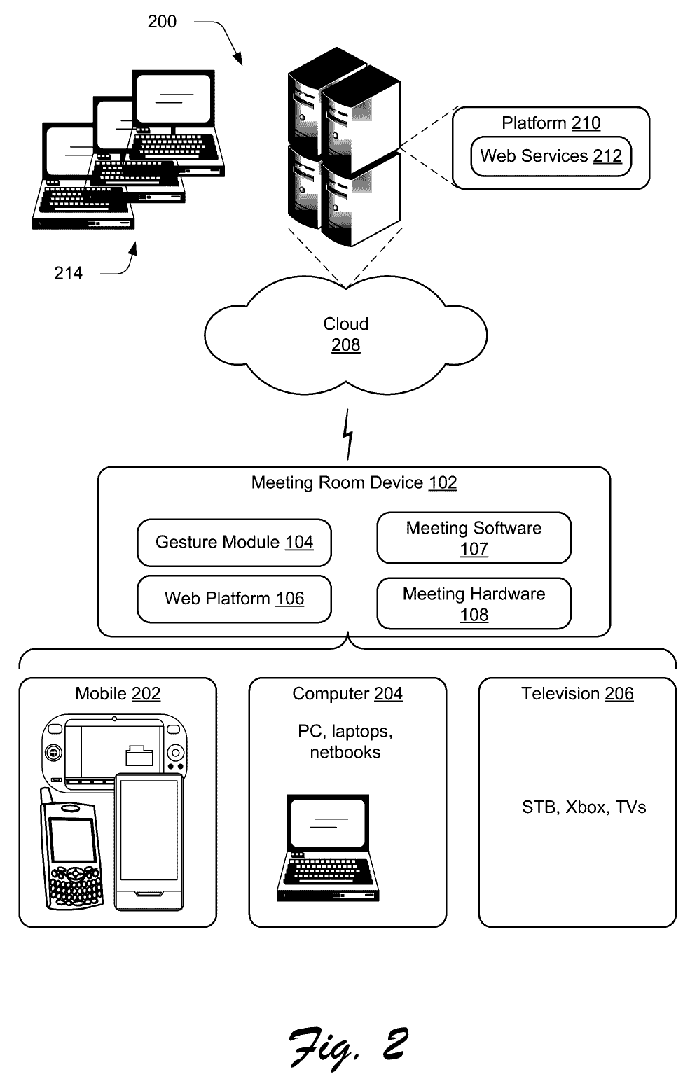

The meeting room device 102 may be configured as a traditional computer (e.g., a desktop personal computer, laptop computer, and so on), a mobile station, a wireless phone, a netbook, a handheld device, and so forth as further described in relation to FIG. 2. Thus, the meeting room device 102 may range from full resource devices with substantial memory and processor resources (e.g., personal computers) to a low-resource device with limited memory and/or processing resources. The meeting room device 102 also includes software that causes the meeting room device 102 to perform one or more operations as described below.

In at least some embodiments, the meeting room device 102 is a large form factor device that provides a canvas for idea collaboration, as will become apparent below.

Meeting room device 102 can include, by way of example and not limitation, a number of different components including a gesture module 104, a web platform 106, meeting software 107, and meeting hardware 108.

The gesture module 104 is operational to provide gesture functionality. The gesture module 104 can be implemented in connection with any suitable type of hardware, software, firmware or combination thereof. In at least some embodiments, the gesture module 104 is implemented in software that resides on some type of computer-readable storage medium examples of which are provided below.

Gesture module 104 is representative of functionality that recognizes gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand as proximal to display device 110 of the meeting room device 102 using touchscreen functionality.

It is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the meeting room device 102 may be configured to detect and differentiate between a touch input (e.g., provided by one or more fingers of the user's hand) and a stylus or pen input (e.g., provided by a stylus 116). The differentiation may be performed in a variety of ways, such as by detecting an amount of the display device 110 that is contacted by a finger of the user's hand versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that meeting room device 102 could be any computing device that is capable of displaying Web pages/documents and connect to the Internet.

Meeting software 107 is representative of software that enables meetings to be conducted using various features which can include, by way of example and not limitation, instant messaging, Voice over IP (VoIP), video conferencing, and the like. The meeting software can also include such things as a cloud-based whiteboard tool that enables meeting participants to write upon the display device 110. The meeting software operates as described above and below.

Meeting hardware 108 is representative of hardware that enables meetings to be conducted as described above and below. The hardware can include, by way of example and not limitation, built-in sensors to help the meeting room device wakeup when a person is in close proximity and track a person's movement so that one or more cameras (e.g., 1080p cameras on each side of the meeting room device) can follow the person. In addition, the meeting hardware 108 can work in concert with the meeting software 107 to provide meeting starts using a single touch. The hardware and software of the meeting room device can also allow participants to share content wirelessly, thus making meetings engaging and productive. The meeting hardware 108 can also include a built-in microphone array.

FIG. 2 illustrates an example system 200 showing the components of FIG. 1, e.g., meeting software 107 and meeting hardware 108, as being implemented in an environment where multiple devices are interconnected through a central computing device. The meeting software 107 and meeting hardware 108 can enable meetings to be conducted using various features which can include, by way of example and not limitation, instant messaging, Voice Over IP, video conferencing, whiteboard functionality, content sharing and the like.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the meeting room device 102 may be configured in a variety of different ways, such as for mobile 202, computer 204, and television 206 uses. Each of these configurations has a generally corresponding screen size and thus the meeting room device 102 may be configured as one of these device classes in this example system 200. For instance, the meeting room device 102 may assume the mobile 202 class of device which includes mobile telephones, music players, game devices, and so on. The meeting room device 102 may also assume a computer 204 class of device that includes personal computers, laptop computers, netbooks, tablets, large form factor devices, and so on. The television 206 configuration includes configurations of device that involve display in a casual environment, e.g., televisions, set-top boxes, game consoles, and so on. Thus, the techniques described herein may be supported by these various configurations of the meeting room device 102 and are not limited to the specific examples described in the following sections.

As described above, meeting room device 102 includes meeting software 107 that operates as described above and below.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the meeting room device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the meeting room device 102 via the Internet or other networks. For example, aspects of the meeting software 107 may be implemented in part on the meeting room device 102 as well as in a distributed fashion via platform 210 that supports web services 212. For example, platform 210 may include, as part of a suite of web services, a meeting service that enables meetings to be conducted as described above and below.

In addition, system 200 can include one or more remote computing devices 214 associated with remote participants who can participate in a meeting organized and conducted through meeting room device 102. Each of the remote computing devices 214 can execute a meeting client that enables communication with meeting software 107.

Participants, such as remote participants, can share resources with the meeting room device 102. When a participant in an online meeting begins to share a resource, such as their display screen, a new application window is automatically opened on the meeting room device 102 and content associated with the participant's computing device is shared within the new application window. By automatically opening a new application window and sharing content therewithin, meeting participants using the meeting room device are relieved of having to physically interact with the meeting room device or meeting software in order to consume the shared content. This, in turn, greatly improves the user experience by enabling the participants to focus on meeting content rather than having to arrange for the content to be shared.

In at least some embodiments, the meeting room device includes a so-called application stage. The application stage represents a display area within which applications may run. In response to a participant sharing a resource, the position(s) and size(s) of windows within the application stage are changed to accommodate a new application window associated with the shared resource. Content associated with the participant's computing device can then be shared within the new application window. An application that was running in the application stage can still continue to run while content associated with the participant's computing device is shared within the new application window. By partitioning the application stage in a manner that allows an application to continue to run in the partitioned application stage, content that is being remotely shared can be shared in a side-by-side fashion along with the application. In many instances, the application may have context with respect to content that is being remotely shared. For example, a whiteboard application may execute in a size-reduced window within the application stage to enable participants to actively make notes relative to the content being remotely shared.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Automatically Opening a New Application Window” describes how a new application window can be automatically opened in accordance with one or more embodiments. Next, a section entitled “Example Method” describes an example method in accordance with one or more embodiments. Following this, a section entitled “Implementation Details” describes aspects of some implementation details in accordance with one or more embodiments. Last, a section entitled “Example Device” describes aspects of an example device that can be utilized to implement one or more embodiments.

Having considered an example operating environment, consider now a discussion of how a new application window can be automatically opened on a meeting room device in accordance with one or more embodiments.

Automatically Opening a New Application Window

As noted above, when a participant in an online meeting begins to share a resource, such as their display screen, a new application window is automatically opened on a meeting room device and content associated with the participant's computing device is shared within the new application window. The participant can be a person in close proximity to the meeting room device, such as being located in an associated meeting room. Alternately or additionally, the participant can be a remote participant who is participating in the meeting by way of a network and a meeting service.

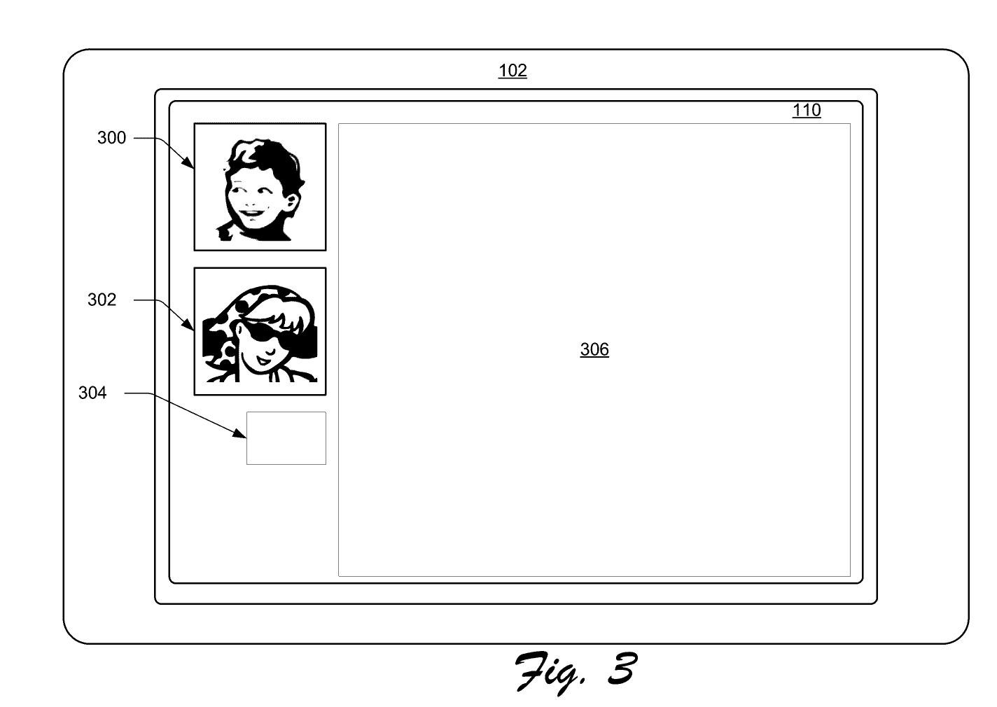

In at least some embodiments, the meeting room device includes a so-called application stage. The application stage represents a display area within which applications may run. In response to a participant sharing a resource, the position(s) and size(s) of windows within the application stage are changed to accommodate a new application window associated with the shared resource. Content associated with the participant's computing device can then be shared within the new application window. An application that was running in the application stage can still continue to run while content associated with the participant's computing device is shared within the new application window. As an example, consider FIG. 3.

There, meeting room device 102 is illustrated as including a display device 110. Assume in this example that a meeting is in process. In this case, display device 110 can include a portion to display avatars or icons 300, 302 associated with meeting participants, e.g., remote participants, as well as videos of participants. In addition, a display portion 304 may show the participants in the current meeting room. In addition, an application stage 306 is provided and constitutes an area within which applications can execute. The application stage is different from the portion that displays avatars or icons associated with meeting participants. Applications executing in application stage 306 can include any suitable type of applications such as, by way of example and not limitation, a whiteboard application, spreadsheet application, word processing application, and the like. The whiteboard application allows users to write upon the display and have its contents shared out amongst meeting participants. The content is displayed on display device 110 can be displayed when a meeting is initiated. That is, when a meeting is initiated avatars or icons associated with meeting participants can be displayed as well as a region associated with the application stage.

Now assume that a meeting participant, either in the meeting room or a remote participant, begins to share a resource, such as a computing screen, into the meeting. For example, a remote participant may indicate by way of their meeting software that they wish to share a resource as by, for example, selecting a suitably-configured user interface instrumentality such as a “share” button on their user interface. Responsive to selecting the user interface instrumentality, a message can be sent to the meeting service to inform the meeting service that the remote participant wishes to share content. The meeting service can, in turn, notify the meeting room device, establish a communication connection to enable sharing of content, and take any other measures to enable content sharing. Resource sharing can take place in any suitable way using any suitable protocol. In at least some embodiments, resource sharing can be accomplished using Remote Desktop Protocol (RDP).

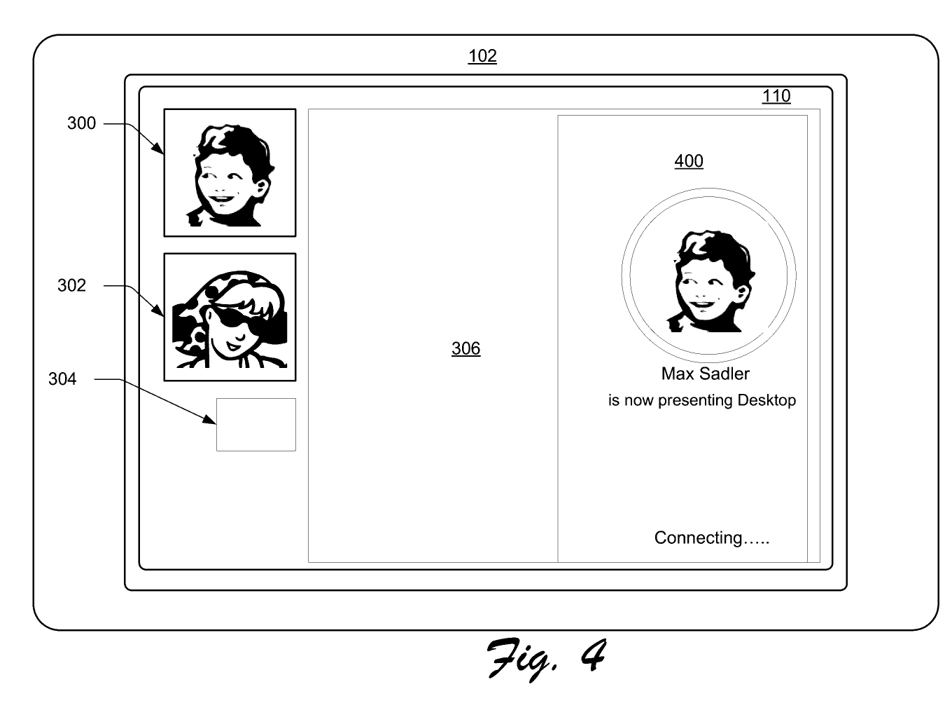

When the meeting software executing on meeting room device 102 ascertains that a meeting participant wishes to share a resource, such as their display screen, the meeting software can automatically open a new application window in which content associated with the resource can be shared. As an example, consider FIG. 4 in which like numerals from FIG. 3 have been utilized.

Notice in FIG. 4, a new application window 400 has been automatically opened within application stage 306. In this particular example, other windows executing inside the application stage 306 can be resized to accommodate the new application window. For example, in the FIG. 3 example, an application window might occupy the entire application stage. However, when a resource is shared, this application window can be resized within the application stage (e.g., to the left of new application window 400) to accommodate the new application window 400. Notice also, in this particular example, that the portion in which participant avatars or icons are displayed remains unchanged in size and that the icons or avatars and other display items remain in their relative locations on the display device. Doing so helps to promote visual continuity and reduce distractions for the participants by relieving them of the burden to visually relocate the avatars or icons of the various participants.

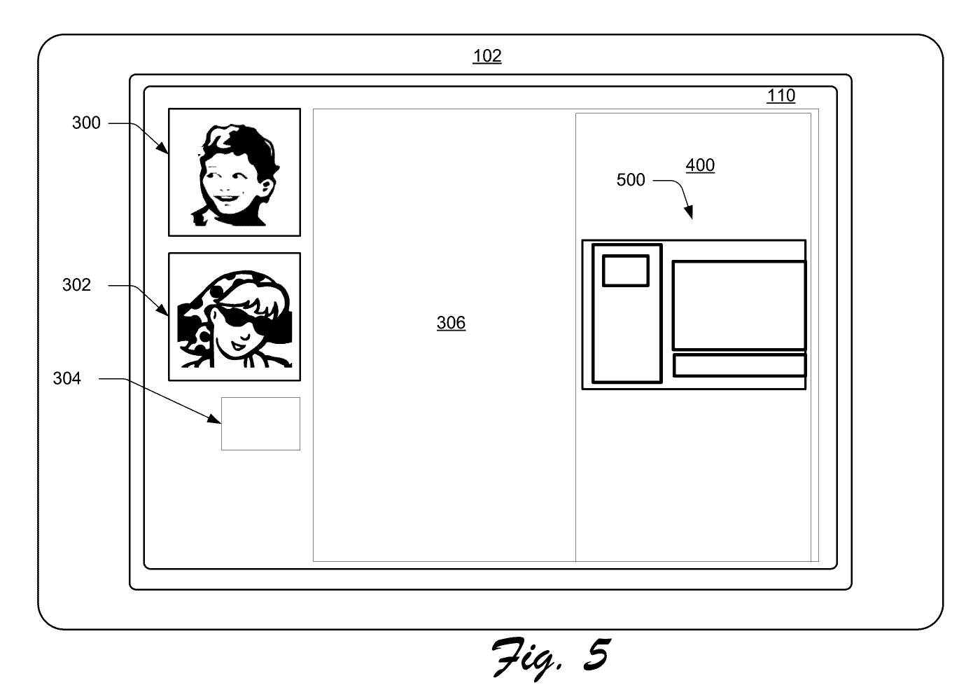

If an application is currently executing in application stage 306, it can continue to execute. In this particular example, the new application window 400 first displays content associated with a “connecting” state. That is, while a suitable sharing connection is being established, the avatar or icon of the person desiring to share content can be displayed to inform the meeting participants who is attempting to share content, along with a title. In this case, the title includes the participant's name and a short message. The title can also include the type of content that is to be shared. In this particular example, the shared content is the participant's desktop content. Once the connection is established to the meeting service, the remote participant's resource can be shared within new application window 400. As an example, consider FIG. 5.

There, the connection has been established with the remote participant for purposes of sharing a desired resource, i.e. the remote participant's display screen. Within the new application window 400, content 500 is displayed. Content 500 constitutes content displayed on the remote participant's display screen. In this particular example, content 500 may include application content that is displayed on the remote participant's display screen. Notice that here as well, the portion in which participant avatars and icons are displayed remains unchanged in size and location. Moreover, the location of the avatars, icons and other display items remains unchanged, thus further promoting visual continuity and reducing distractions.

In the illustrated and described embodiment, a new application window is automatically opened on the meeting room device when the meeting room device and/or meeting software executing thereon receives a notification that a participant, such as a remote participant, wishes to share a resource. By automatically opening the new application window and enabling content to be displayed therein, meeting participants who are local to the meeting room device are relieved from the burden of having to interact with the software to permit sharing. This can enable resources to be shared in an efficient manner in which meeting room participants can remain focused on the meeting and its content, rather than having to disengage and interact with the meeting software to permit content sharing. This, in turn, reduces meeting room distractions and can enable a much more efficiently conducted meeting.

Having considered an example meeting room device and an associated user interface, consider now an example method in accordance with one or more embodiments.

### Example Method

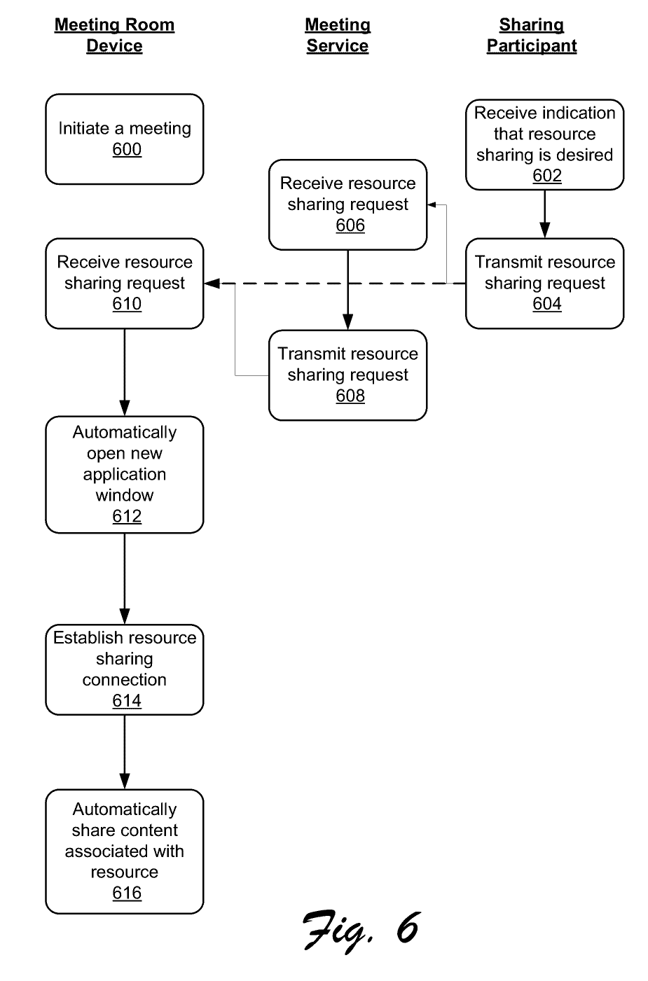

FIG. 6 is a flow diagram that describes steps in a method in accordance with one or more embodiments. Aspects of the method about to be described can be performed by different entities including, by way of example and not limitation, a meeting room device, a meeting service, and a sharing participant. Accordingly, the flow diagram includes three columns, each of which being labeled according to the computing device and/or software associated with the entity performing the described actions.

Step 600 initiates a meeting. This step can be performed by the meeting room device and can include those actions that are typically utilized to initiate a meeting including receiving participant registrations, establishing communication connections with the various participants, organizing resources, and the like.

Step 602 receives an indication that resource sharing is desired. This step can be performed in any suitable way. For example, a participant can indicate by way of their meeting software that resource sharing is desired. Examples of how this can be done are provided above. Responsive to receiving an indication that resource sharing is desired, step 604 transmits a resource sharing request. In at least some embodiments, the resource sharing request can be transmitted to a suitably configured meeting service, such as one that executes in or over a network such as the Internet. If this is the case, the meeting service receives the resource sharing request at step 606 and, at step 608, transmits the resource sharing request to the meeting room device. Alternately, in the event a meeting service is not employed for the purpose of enabling resource sharing, the computing device of the sharing participant can transmit the resource sharing request to the meeting room device, as indicated by the dashed line.

Step 610 receives the resource sharing request at the meeting room device. Responsive to receiving the resource sharing request, step 612 automatically opens a new application window. Examples of how this can be done are provided above and below. In at least some embodiments, in response to a participant sharing a resource, the position(s) and size(s) of windows within the application stage are changed to accommodate a new application window associated with the shared resource. Step 614 establishes a resource sharing connection. The step can be performed in any suitable way. For example, the resource sharing connection can be established through the meeting service. Alternately or additionally, a resource sharing connection can be established directly between the meeting room device and a computing device of the sharing participant. Step 616 automatically shares content associated with the resource. This step can include sharing the content in the new application window.

Having considered an example method in accordance with one or more embodiments, consider now a discussion of various implementation details that can be utilized in connection with the above-described embodiments.

Implementation Details

In at least some embodiments, certain default size considerations can be taken into account to enhance the user's experience. For example, if the content resolution of the content that is to be shared is larger than the new application window size, the content can be fitted to the new application window using suitable scaling techniques such that all content is visible without scrolling. This is referred to as “fit to window” processing. If, on the other hand, the content that is to be shared is smaller than or equal to the new application window size, the content to be shared can be displayed at 100% of its actual size. Content can also be magnified, e.g. up to a cap such as 200%, to promote readability and reduce distortion. Furthermore, when content does not fill the new application window, it can be centered vertically and/or horizontally to provide a visually symmetrical display.

With respect to the connecting or connection state, certain content can be displayed such as that described in FIG. 4. When the participant who has been sharing the resource terminates sharing, a display similar to that of FIG. 4 can be displayed along with the title “Max Sadler has stopped presenting.” After a predefined or predetermined period of time, such as five seconds, the new application window can be automatically closed and the application stage 306 can be resized to assume its original size.

With respect to content manipulation operations performed within the new application window, consider the following. In at least some embodiments, content that is displayed within the new application window can be manipulated through keyboard input, mouse input, touch gestures or natural user interface (NUI) gestures and the like. For example, pinch-to-zoom operations to zoom in and out can be supported. Additionally, other gestures such as double tap gestures to change default sizes can be supported. In at least some instances, when the content size is larger than the new application window size, gesture operations can be supported to allow users to swipe to pan or scroll the content in the window.

In at least some embodiments, when the new application window has been opened and a participant is presenting by sharing a resource, it is possible for another participant to begin presenting into the meeting, thus terminating the sharing from the first participant. In these instances, the new application window can be utilized to show or otherwise convey to the meeting participants that a change of presenter is about to occur. So, for example, a message may be received that the current presentation has stopped and a new presentation is beginning. In this case, the new application window can stop displaying the previously shared content and display a new presenter flow as if a new application window had been opened for the first time. The new presenter flow would be similar in visual appearance to the content appearing in FIG. 4.

### Example Meeting Room Device

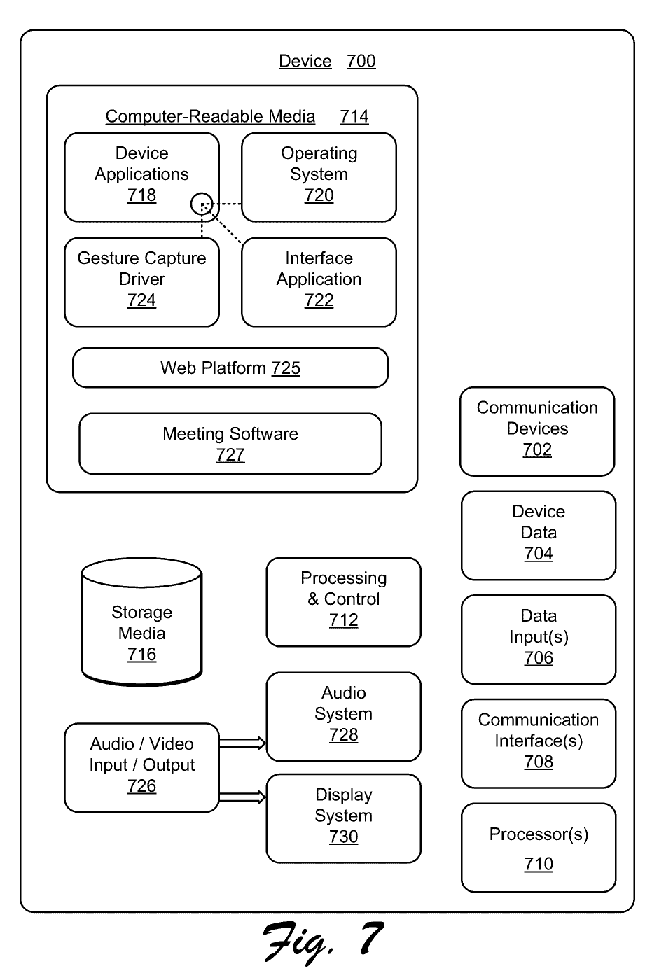

FIG. 7 illustrates various components of an example meeting room device 700 that can be implemented as any type of computing device as described with reference to FIGS. 1 and 2 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700, such as in the context of the meeting.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and a gesture capture driver 724 that are shown as software modules and/or computer applications. The gesture capture driver 724 is representative of software that is used to provide an interface with a device configured to capture a gesture, such as a touchscreen, track pad, camera, and so on. Alternatively or in addition, the interface application 722 and the gesture capture driver 724 can be implemented as hardware, software, firmware, or any combination thereof. Additionally, computer readable media 714 can include a web platform 725 and meeting software 1027 that functions as described above.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### Example Implementations

Example implementations employing a meeting summary described herein include, but are not limited to, one or any combination of one or more of the following example:

A computer-implemented method comprising: initiating, by a meeting room device, an online meeting, said initiating comprising displaying on an associated display device: a portion with avatars or icons associated with meeting participants, and an application stage that provides an area within which one or more applications can execute; responsive to a meeting participant beginning to share a resource, automatically opening a new application window within the application stage; and automatically sharing content associated with the resource in the new application window.

A method as described above, wherein said automatically opening a new application window comprises reducing the size of other application windows within the application stage.

A method as described above, wherein said automatically opening a new application window comprises leaving the size of the portion with avatars or icons unchanged.

A method as described above, wherein said automatically opening a new application window comprises leaving the avatars or icons in their relative locations on the display device.

A method as described above, wherein said automatically opening a new application window comprises: leaving the size of the portion with avatars or icons unchanged; and leaving the avatars or icons in their relative locations on the display device.

A method as described above, wherein said automatically opening a new application window comprises: leaving the size of the portion with avatars or icons unchanged; leaving the avatars or icons in their relative locations on the display device; and reducing the size of other application windows within the application stage.

A computer-implemented method comprising: initiating, by a meeting room device, an online meeting, said initiating comprising displaying on an associated display device: a portion with avatars or icons associated with meeting participants, and an application stage that provides an area within which one or more applications can execute; responsive to a meeting participant beginning to share a resource, automatically opening a new application window within the application stage, said automatically opening comprising displaying content associated with a connecting state, said content including an avatar or icon of a person desiring to share content, and a title; and automatically sharing content associated with the resource in the new application window.

A method as described above, wherein the title includes the name of the person desiring to share content.

A method as described above, wherein the title includes the type of content that is to be shared.

A method as described above, wherein the title includes the name of the person desiring to share content and the type of content that is to be shared.

A method as described above, wherein said automatically opening a new application window comprises reducing the size of other application windows within the application stage.

A method as described above, wherein said automatically opening a new application window comprises leaving the size of the portion with avatars or icons unchanged.

A method as described above, wherein said automatically opening a new application window comprises leaving the avatars or icons in their relative locations on the display device.

A method as described above, wherein said automatically opening a new application window comprises: leaving the size of the portion with avatars or icons unchanged; and leaving the avatars or icons in their relative locations on the display device.

A method as described above, wherein said automatically opening a new application window comprises: leaving the size of the portion with avatars or icons unchanged; leaving the avatars or icons in their relative locations on the display device; and reducing the size of other application windows within the application stage.

A meeting room device comprising: one or more processors; one or more computer readable media embodying computer-readable instructions which, when executed by the one or more processors, perform operations comprising: initiating an online meeting, said initiating comprising displaying on an associated display device: an application stage that provides an area within which one or more applications can execute, at least one application comprising a whiteboard application; responsive to a meeting participant beginning to share a resource, automatically opening a new application window within the application stage; and automatically sharing content associated with the resource in the new application window.

A meeting room device as described above, wherein said automatically opening a new application window comprises reducing the size of other application windows within the application stage.

A meeting room device as described above, wherein said automatically opening a new application window comprises leaving the size of a displayed portion having avatars or icons associated with meeting participants unchanged.

A meeting room device as described above, wherein said automatically opening a new application window comprises leaving locations of displayed avatars or icons associated with meeting participants in their relative locations on the display device.

A meeting room device as described above, wherein said automatically opening a new application window comprises: leaving the size of a displayed portion having avatars or icons associated with meeting participants unchanged; and leaving displayed avatars or icons within the displayed portion in their relative locations on the display device.

### CONCLUSION

In at least some embodiments, when a participant in an online meeting begins to share a resource, such as their display screen, a new application window is automatically opened on a meeting room device and content associated with the participant's computing device is shared within the new application window. The participant can be a person in close proximity to the meeting room device. Alternately or additionally, the participant can be a remote participant.

In at least some embodiments, the meeting room device includes a so-called application stage. The application stage represents a display area within which applications may run. In response to a participant sharing a resource, the position(s) and size(s) of windows within the application stage are changed to accommodate a new application window associated with the shared resource. Content associated with the participant's computing device can then be shared within the new application window. An application that was running in the application stage can still continue to run while content associated with the participant's computing device is shared within the new application window.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
initiating, by a meeting room device, an online meeting, said initiating comprising displaying on an associated display device:
a portion with avatars or icons associated with meeting participants, and
an application stage that provides an area within which one or more applications can execute;
responsive to a meeting participant beginning to share a resource, automatically opening a new application window within the application stage; and
automatically sharing content associated with the resource in the new application window.

2. The method of claim 1, wherein said automatically opening a new application window comprises reducing the size of other application windows within the application stage.

3. The method of claim 1, wherein said automatically opening a new application window comprises leaving the size of the portion with avatars or icons unchanged.

4. The method of claim 1, wherein said automatically opening a new application window comprises leaving the avatars or icons in their relative locations on the display device.

5. The method of claim 1, wherein said automatically opening a new application window comprises:
leaving the size of the portion with avatars or icons unchanged; and
leaving the avatars or icons in their relative locations on the display device.

6. The method of claim 1, wherein said automatically opening a new application window comprises:
leaving the size of the portion with avatars or icons unchanged;
leaving the avatars or icons in their relative locations on the display device; and
reducing the size of other application windows within the application stage.

7. A computer-implemented method comprising:
initiating, by a meeting room device, an online meeting, said initiating comprising displaying on an associated display device:
a portion with avatars or icons associated with meeting participants, and
an application stage that provides an area within which one or more applications can execute;
responsive to a meeting participant beginning to share a resource, automatically opening a new application window within the application stage, said automatically opening comprising displaying content associated with a connecting state, said content including an avatar or icon of a person desiring to share content, and a title; and
automatically sharing content associated with the resource in the new application window.

8. The method of claim 7, wherein the title includes the name of the person desiring to share content.

9. The method of claim 7, wherein the title includes the type of content that is to be shared.

10. The method of claim 7, wherein the title includes the name of the person desiring to share content and the type of content that is to be shared.

11. The method of claim 7, wherein said automatically opening a new application window comprises reducing the size of other application windows within the application stage.

12. The method of claim 7, wherein said automatically opening a new application window comprises leaving the size of the portion with avatars or icons unchanged.

13. The method of claim 7, wherein said automatically opening a new application window comprises leaving the avatars or icons in their relative locations on the display device.

14. The method of claim 7, wherein said automatically opening a new application window comprises:
leaving the size of the portion with avatars or icons unchanged; and
leaving the avatars or icons in their relative locations on the display device.

15. The method of claim 7, wherein said automatically opening a new application window comprises:
leaving the size of the portion with avatars or icons unchanged;
leaving the avatars or icons in their relative locations on the display device; and
reducing the size of other application windows within the application stage.

16. A meeting room device comprising:
one or more processors;
one or more computer readable media embodying computer-readable instructions which, when executed by the one or more processors, perform operations comprising:
initiating an online meeting, said initiating comprising displaying on an associated display device:
an application stage that provides an area within which one or more applications can execute, at least one application comprising a whiteboard application;
responsive to a meeting participant beginning to share a resource, automatically opening a new application window within the application stage; and
automatically sharing content associated with the resource in the new application window.

17. The meeting room device of claim 16, wherein said automatically opening a new application window comprises reducing the size of other application windows within the application stage.

18. The meeting room device of claim 16, wherein said automatically opening a new application window comprises leaving the size of a displayed portion having avatars or icons associated with meeting participants unchanged.

19. The meeting room device of claim 16, wherein said automatically opening a new application window comprises leaving locations of displayed avatars or icons associated with meeting participants in their relative locations on the display device.

20. The meeting room device of claim 16, wherein said automatically opening a new application window comprises:
leaving the size of a displayed portion having avatars or icons associated with meeting participants unchanged; and
leaving displayed avatars or icons within the displayed portion in their relative locations on the display device.
